(19) United States
(12) Patent Application Publication
(10) Pub. No.: US 2013/0326612 A1
(43) Pub. Date: Dec. 5, 2013

(54) Apparatus and Method for Forming Secure Computational Resources

(71) Applicant: David Naccache, Paris (FR)

(72) Inventor: David Naccache, Paris (FR)

(73) Assignee: CROCUS TECHNOLOGY INC., Sunnyvale, CA (US)

(21) Appl. No.: 13/488,340

(22) Filed: Jun. 4, 2012

(51) Int. Cl. G06F 21/00

(52) U.S. Cl. 726/16

(57) ABSTRACT

A computer implemented method includes collecting logged operations associated with a computation resource. Permitted operations for the computation resource are inferred based at least in part on the logged operations. A computation resource is augmented to block all operations that can be performed by the computation resource except the permitted operations.

### FIELD OF THE INVENTION

This invention relates generally to computational resources, such as a software application, integrated circuit design and the like. More particularly, this invention relates to techniques for forming a secure computational resource operative only in authorized modes.

### BACKGROUND OF THE INVENTION

Computational resources are commonly subject to attacks. For example, a computational resources in the form of a software application operating on a general purpose computer may be subject to an attack, which results in access to unauthorized information (e.g., bank account information) or unauthorized resources (e.g., memory locations, which may cause a system failure). A computational resource in the form of an embedded processor may be subject to an attack that allows a set-top box to access television cable channels without proper authorization. Alternately, a computational resource in the form of an integrated circuit card (also referred to as a smart card or chip card) may be subject to fraudulent activity. For example, the memory and/or microprocessor components associated with such a card may be manipulated to enable functionality that was not contemplated in an authorized deployment.

Consequently, it is desirable to provide improved techniques for forming secure computational resources.

### SUMMARY OF THE INVENTION

A computer implemented method includes collecting logged operations associated with a computation resource. Permitted operations for the computation resource are inferred at least in part on the logged operations. A computation resource is augmented to block all operations that can be performed by the computation resource except the permitted operations.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates processing operations associated with an embodiment of the invention.

Like reference numerals refer to corresponding parts throughout the several views of the drawings.

### DETAILED DESCRIPTION OF THE INVENTION

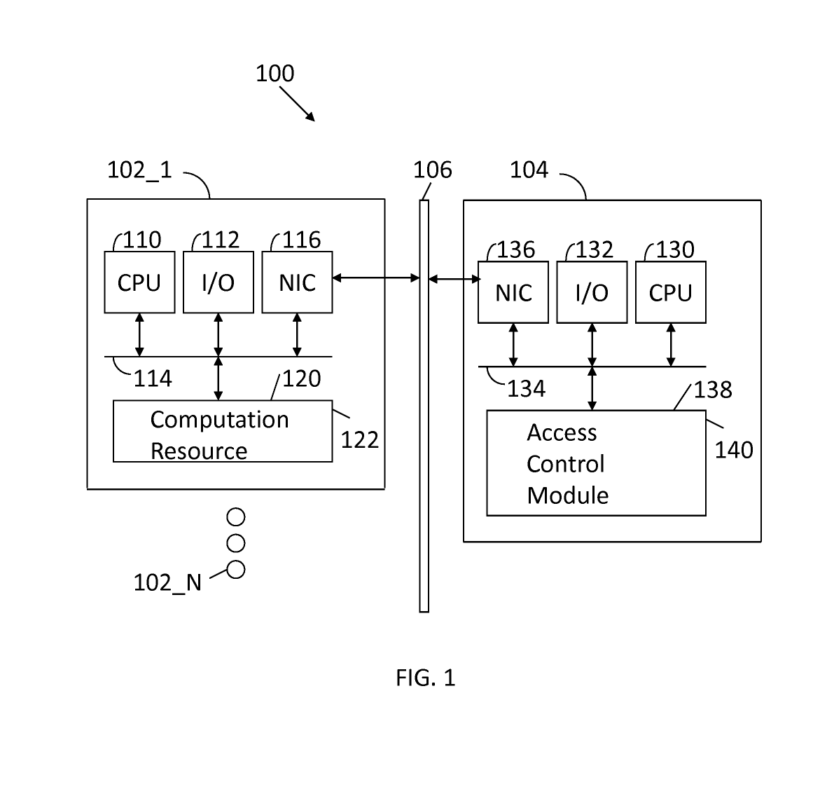

FIG. 1 illustrates a system 100 configured in accordance with an embodiment of the invention. The system 100 includes client devices 102_1 through 102_N linked to a server 104 via a network 106, which may be any wired or wireless network. The client device 102 may be any hardware or software resource. In one embodiment, the client device is a computer with standard components, such as a central processing unit 110 and input/output devices 112 connected via a bus 114. The input/output devices 112 may include a keyboard, mouse, display, printer and the like. A network interface circuit 116 is also connected to the bus 114 to provide interconnectivity with network 106. A memory 120 is also connected to the bus 114. The memory 120 stores a computation resource 122, which may be a software application.

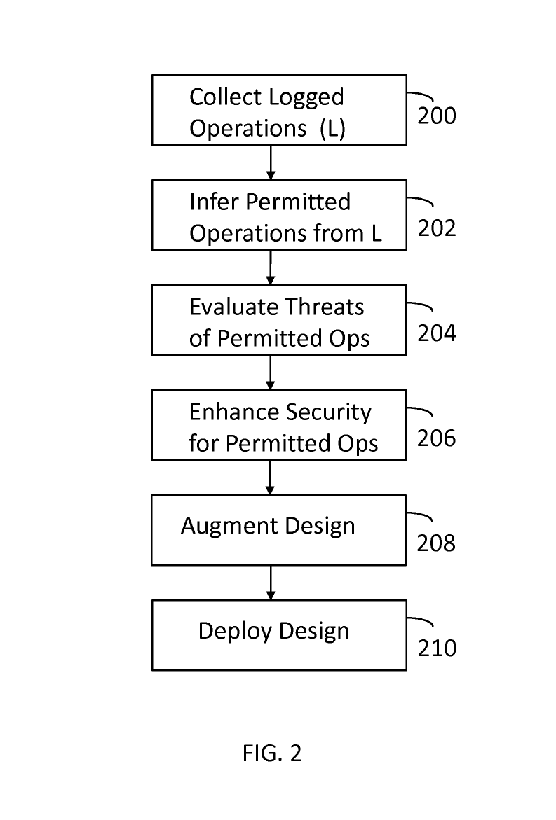

The server 104 also includes standard components, such as a central processing unit 130 and input/output devices 132 connected via a bus 134. A network interface circuit 136 is also connected to the bus 134. A memory 138 stores an access control module 140. The access control module 140 includes executable instructions to implement operations of the invention. FIG. 2 illustrates an embodiment of such operations.

The first operation of FIG. 2 is to collect logged operations (L) 200. That is, the access control module 140 collects logged operations associated with the use of a computational resource. For example, in the system of FIG. 1, computation resource 122 is executed. That is, it is run in its intended matter so as to receive and execute commands, receive parameters and the like. These operations are logged by the computation resource 122. The logged operations are then periodically passed over network 106 to server 104. For example, the computation resource 122 may include executable instructions to maintain a transaction log, which is periodically updated to server 104. Logged operations may be received by computer 104 via direct cable links and other non-networked links.

In another embodiment, the computation resource is an integrated circuit card. As used herein, an integrated circuit card is an integrated circuit encapsulated in a pocket sized piece of plastic. In one embodiment, the plastic is 85.6 mm×53.98 mm×0.76 mm, a widely acknowledged form factor. The integrated circuit of the integrated circuit card includes a processor component and one or more memory components, such as a read only memory, a programmable read only memory, an erasable programmable read only memory, an electrically erasable programmable read only memory and/or a random access memory. An integrated circuit card associated with an embodiment of the invention includes a non-volatile memory to store logged operations. For example, International Organization for Standardization (ISO) commands applied to the card may be logged. In addition, data object manipulations may be logged. Preferably, the computation resource is subject to all normal use scenarios. The use scenarios may be actual uses in a deployed setting or in a test environment.

A standard integrated circuit card interface device (e.g., a card reader) may then be used to access the logged operations and convey them to the access control module 140. The collection of logged operations typically entails the collection of logged operations from many instances of a computational resource.

After an adequate number of logged operations are collected, permitted operations are inferred 202. Executable instructions of the access control module 140 evaluate the logged operations using rules to infer the permitted operations. Permitted operations are those operations associated with the intended use of a computation resource. The logged operations may be used as a template for defining permitted operations. That is, the logged operations may be deemed permitted operations. All other modalities of the computation resource may then be restricted. For example, all data object not used in the logged operations may be subsequently blocked. Alternately, or in addition, all data objects used in a specific way may be blocked for all other uses. Alternately, or in addition, all unused commands may be blocked. Alternately, or in addition, all command sequences that were not witnessed by the computation resource may be forbidden.

In one embodiment, a table of permitted operations is formed. The table is added to the computation resource, which is then configured to check for a permitted operation prior to execution of any operation. If the requesting operation is not found in the table, it is blocked (i.e., rendered forbidden) by the computation resource.

The permitted operations effectively bound the operational modalities of the computation resource. Possible threats associated with the permitted operations may then be evaluated 204. Observe here that the threat evaluation process is simplified because all operational modalities of the computation resource do not have to be considered. Only the witnessed operations and their interactions need to be evaluated. Executable instructions of the access control module 140 may apply security rules to evaluate potential threats associated with the permitted operations.

Prophylactic measures may then be taken to enhance the security for permitted operations 206. For example, additional authentication may be required for certain permitted operations. In other cases, certain interactions between permitted operations may be precluded. In extreme cases some permitted operations might turn out to be insecure. In such cases, the previously permitted operations are blocked. The access control module 140 may automatically generate code to implement these enhanced security operations. As a result, every component in the computation resource 122 is able to access only such information and resources that are necessary for a legitimate purpose.

The design is then augmented 208. For example, the original design may be supplemented with a permissions table that is checked prior to execution of any requested operation.

Subsequently, the computation resource is deployed 210. Again, the computation resource may be a software application operating on a general purpose computer, a software application operating on an embedded device (e.g., a set-top box), a hardwired circuit, a field programmable logic device, an integrated circuit card and the like.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising;
collecting logged operations associated with a computation resource;
inferring permitted operations for the computation resource based at least in part on the logged operations; and
augmenting a computation resource to block all operations that can be performed by the computation resource except the permitted operations.

2. The computer implemented method of claim 1 further comprising evaluating threats associated with the permitted operations.

3. The computer implemented method of claim 2 further comprising enhancing security associated with the permitted operations in response to evaluating the threats.

4. The computer implemented method of claim 1 wherein the computation resource is selected from an application program operative on a general purpose computer, an application program operative on an embedded processor and an integrated circuit card.
